(19) United States
(12) Patent Application Publication
(10) Pub. No.: US 2002/0144234 A1
(43) Pub. Date: Oct. 3, 2002

(54) Naming scheme for reducing complexity of application creation tools

(76) Inventor: Shu-Huar Joseph Yeh, San Jose, CA (US)

Correspondence Address: SAWYER LAW GROUP, P.O. Box 51418, Palo Alto, CA, 94303, US

(21) Appl. No.: 09/828,587

(22) Filed: Mar. 29, 2001

(51) Int. Cl. G06F 9/44

(52) U.S. Cl. 717/106

(57) ABSTRACT

An application creation tool includes: a first component and a second component, where a name of the first and second components in accordance with a naming scheme is based on a plurality of attributes for an application which the first and the second components create. Each component pertains to one variation of the combination of attributes, such as the programming language, the application type, the server type, and the service type for the application to be created. Each component is named according to the naming scheme based on these attributes. When a service request for the tool is issued, the tool uses the four attributes to determine the name of the appropriate component. In this manner, the complexity of the application creation tool is reduced. This makes the tool easily maintainable and easier to upgrade.

### FIELD OF THE INVENTION

The present invention relates to database networks, and more particularly to application creation tools in database networks.

### BACKGROUND OF THE INVENTION

FIG. 1 illustrates a conventional database network. The network includes a server 102, a database 104, and a plurality of clients 106. At least one of the clients 106 has an application creation tool 108. The tool 108 is used by application developers for creating software applications 110 which will eventually reside on the server 102. During development of the server applications 110, the developers can use the tool 108 to query for the status of the applications 110 or to run tests on the applications 110.

These server applications 110 can be created with different programming languages (such as Structured Query Language (SQL), Java®, C, or C++), for different server types (such as Windows NT®, AIX®, OS/390®, or Linux® operating systems), as different application types (such as stored procedures or user-defined functions), and/or to perform different service types. (AIX and OS/390 are registered trademarks of International Business Machines Corporation in the United States, other countries, or both. Java and Java-based trademarks are trademarks of Sun Microsystems Inc. in the United States, other countries, or both. Windows NT is a trademark of Microsoft Corporation in the United States, other countries, or both.) Conventionally, these four attributes are accommodated in the code of tool 108 code using one component. For example, if the tool 108 is written in Java, the one component is a single class. This class would use a series of IF-THEN-ELSE statements to accommodate the different variations of the four attributes listed above.

However, the use of one component in this manner makes the code of the tool 108 very complex and difficult to maintain. The code must anticipate every variation that may be used by the application developer. To upgrade the tool 108 to handle a new variation, the code of the tool 108 must be modified. This required a great deal of time and effort.

Accordingly, there exists a need for a method and system for reducing the complexity of an application creation tool. The present invention addresses such a need.

### SUMMARY OF THE INVENTION

The present invention provides a method, system, and article of manufacture for reducing the complexity of an application creation tool. The tool includes: a first component and a second component, where a name of the first and second components in accordance with a naming scheme is based on a plurality of attributes for an application which the first and the second components create. Each component pertains to one variation of a combination of attributes, such as a programming language, an application type, a server type, and a service type for the application to be created. Each component is named according to the naming scheme based on these attributes. When a service request for the tool is issued, the tool uses the four attributes to determine the name of the appropriate component. In this manner, the complexity of the application creation tool is reduced. This makes the tool easier to maintain and upgrade.

### DESCRIPTION OF THE FIGURES

FIG. 1 illustrates a conventional database network.

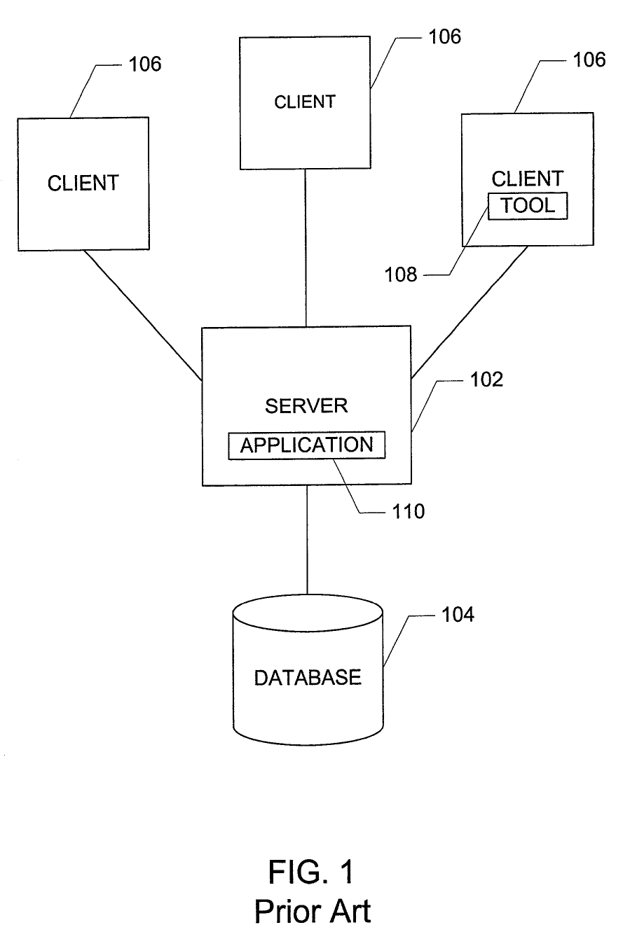

FIG. 2 illustrates an application creation tool in accordance with the preferred embodiment of the present invention.

FIG. 3 is a flowchart illustrating the use of the application creation tool in accordance with the preferred embodiment of the present invention.

### DETAILED DESCRIPTION

The present invention provides a method, system, and article of manufacture for reducing the complexity of an application creation tool. The following description is presented to enable one of ordinary skill in the art to make and use the invention and is provided in the context of a patent application and its requirements. Various modifications to the preferred embodiment will be readily apparent to those skilled in the art, and the generic principles herein may be applied to other embodiments. Thus, the present invention is not intended to be limited to the embodiment shown, but is to be accorded the widest scope consistent with the principles and features described herein.

The preferred embodiment in accordance with the present invention provides an application creation tool which has a plurality of components. Each component pertains to one variation of a combination of attributes, such as the programming language, the application type, the server type, and the service type for the application to be created. Each component and its interface is named according to a naming scheme based on these attributes. When a service request for the tool is issued, the tool uses the four attributes by the issued service request to determine the name of the appropriate component in accordance with the naming scheme. The appropriate component is then loaded. In this manner, the complexity of the application creation tool is reduced. This makes the tool more easily maintainable and easier to upgrade.

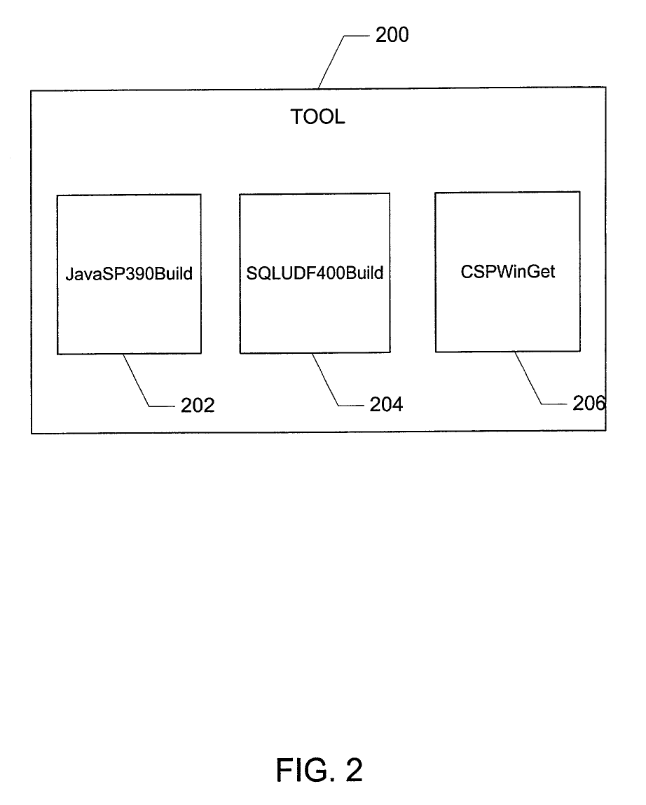

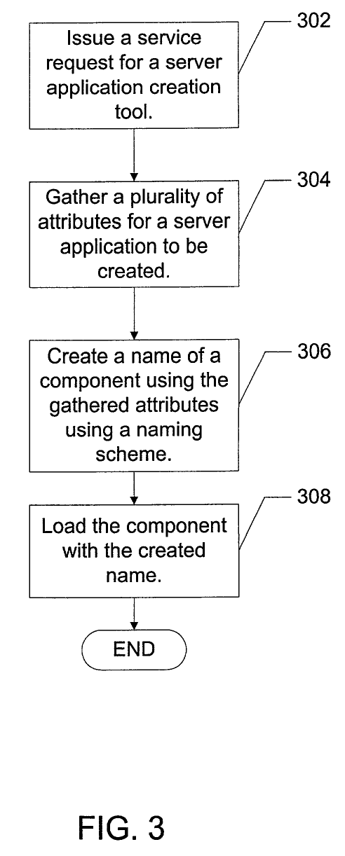

To more particularly describe the features of the present invention, please refer to FIGS. 2 and 3 in conjunction with the discussion below.

FIG. 2 illustrates an application creation tool in accordance with the preferred embodiment of the present invention. The tool 200 comprises a plurality of components 202, 204, and 206. Each component pertains to one variation of the combination of attributes, such as the programming language, the application type, the server type, and the service type for the application to be created. Each component 202, 204, and 206 has a unique name according to a naming scheme. In the preferred embodiment, the names of the components 202, 204, and 206 according to the naming scheme is based on the four attributes of the application to be created: programming language, application type, server type, and service type, in this order. A component's interface is named after the service type it provides.

For example, assume that an application to be created has the following four attributes: (1) programming language=Java, (2) application type=stored procedure, (3) server type=S/390, and (4) service type=Build or Create Application. Using the naming scheme in accordance with the preferred embodiment of the present invention, the component 202 for creating an application with these attributes would be named “JavaSP390Build”. a second example, assume that an application to be created has the following four attributes: (1) programming language=SQL, (2) application type=user-defined function, (3) server type=OS/400, and (4) service type=Build or Create Application. Using the naming scheme in accordance with the preferred embodiment of the present invention, the component 204 for creating an application with these attributes would be named “SQLUDF400Build”.

For a third example, assume that an application to be created has the following four attributes: (1) programming language=C, (2) application type=stored procedure, (3) server type=windows, and (4) service type=Get or Query Application Status. Using the naming scheme in accordance with the preferred embodiment of the present invention, the component 206 for creating an application with these attributes would be named “CSPWinGet”.

For a fourth example, assume that an application to be created has the following four attributes: (1) programming language Java, (2) application type=user-defined function, (3) server type=windows, and (4) service type=Run or Test Application. Using the naming scheme in accordance with the preferred embodiment of the present invention, a component for creating an application with these attributes would be named “JavaUDFWinRun”.

Since each component 202, 204, and 206 provides an interface which is named according to its type of service, the JavaSP390Build component 202 provides an interface named “BuildIt”. The CSPWinGet component 206 provides an interface named “GetIt”, etc.

FIG. 3 is a flowchart illustrating the use of the application creation tool in accordance with the preferred embodiment of the present invention. First, a service request the tool 200 is issued to create a server application, via step 302. When the request is issued, the request provides the tool 200 with information describing the application, which includes the four attributes discussed above. The tool 200 next gathers the plurality of attributes for the server application to be created, via step 304. The tool 200 then creates the name of a component 202 using the gathered attributes using the naming scheme, via step 306. Assuming that a component with the created name exists, the tool 200 then loads the component 202 with this name, via step 308. The service can then be performed through the interface provided by the instance of the component 202.

For example, assume that the DB2® has the tool 200 which uses the naming scheme in accordance with the preferred embodiment of the present invention. (DB2 is a trademark of International Business Machines Corporation in the United States, other countries, or both.) The components 202, 204, and 206 are implemented using the Java programming language, with each component being a Java class. The Java classes, and the associated Java files, are named using the naming scheme in accordance with the preferred embodiment of the present invention. The interfaces are also named according to the naming scheme and implemented through the Java interface.

The tool 200 in DB2 has a Class Factory which is responsible for creating an instance of the appropriate component 202, 204, or 206 for a particular service request, based on the application's four attributes. The attributes of the application is maintained by a “project” created by the tool 200 in DB2. When a service request for the application is issued, via step 302, the Class Factory is given the meta information of the application. The Class Factory gathers the attributes of the application from the meta information, via step 304. The Class Factory composes a character string according to the naming scheme using the gathered attributes, via step 306. The Class Factory then attempts to load the Java class named with that character string, via step 308.

Although the present invention has been described with the four attributes described above, one of ordinary skill in the art will understand that other types, numbers, or orders of attributes may be used without departing from the spirit and scope of the present invention.

A method, system, and article of manufacture for reducing the complexity of an application creation tool has been disclosed. The application creation tool has a plurality of components. Each component pertains to one variation of the combination of attributes, such as the programming language, the application type, the server type, and the service type for the application to be created. Each component and its interface is named according to a naming scheme based on these attributes. When a service request for the tool is issued, the tool uses the four attributes provided by the issued service request to determine the name of the appropriate component in accordance with the naming scheme. The appropriate component is then loaded. To support a new programming language, application type, server type, and/or service type, a new component may be added which is named using the naming scheme. There is no need to change any of the existing components. In this manner, the complexity of the application creation tool is reduced. This makes the tool more easily maintainable and easier to upgrade.

Although the present invention has been described in accordance with the embodiments shown, one of ordinary skill in the art will readily recognize that there could be variations to the embodiments and those variations would be within the spirit and scope the present invention. Accordingly, many modifications may be made by one of ordinary skill in the art without departing from the spirit and scope of the appended claims.

What is claimed is:

1. An application creation tool, comprising:
a first component, wherein a name of the first component in accordance with a naming scheme is based on a plurality of attributes for an application which the first component creates; and
a second component, wherein a name of the second component in accordance with the naming scheme is based on the plurality of attributes for the application which the second component creates.

2. The application creation tool of claim 1, wherein the plurality of attributes comprises at least one of:
a programming language;
an application type;
a server type; and
a service type.

3. The application creation tool of claim 1, wherein the first component is a first Java class.

4. The application creation tool of claim 1, wherein the second component is a second Java class.

5. A system, comprising:
a server;
a client coupled to the server, wherein the client comprises a server application creation tool, wherein the server application creation tool comprises:
a first component, wherein a name of the first component in accordance with a naming scheme is based on a plurality of attributes for a server application which the first component creates, and
a second component, wherein a name of the second component in accordance with the naming scheme is based the plurality of attributes for the server application which the second component creates.

6. The system of claim 5, wherein the plurality of attributes comprises at least one of:
a programming language;
an application type;
a server type; and
a service type.

7. The system of claim 5, wherein the first component is a first Java class.

8. The system of claim 5, wherein the second component is a second Java class.

9. A method for creating a server application, comprising the steps of:
(a) issuing a service request for a server application creation tool;
(b) gathering a plurality of attributes for a server application to be created;
(c) creating a name of a component using the gathered attributes using a naming scheme; and
(d) loading a component having the created name.

10. The method of claim 9, wherein the plurality of attributes comprises at least one of:
a programming language;
an application type;
a server type; and
a service type.

11. The method of claim 9, wherein the component is a Java class.

12. A computer readable medium with program instructions for creating a server application, the instructions comprising the steps of:
(a) issuing a service request for a server application creation tool;
(b) gathering a plurality of attributes for a server application to be created;
(c) creating a name of a component using the gathered attributes using a naming scheme; and
(d) loading a component having the created name.

13. The medium of claim 12, wherein the plurality of attributes comprises at least one of:
a programming language;
an application type;
a server type; and
a service type.

14. The medium of claim 12, wherein the component is a Java class.
